(19) United States
(12) Patent Application Publication
(10) Pub. No.: US 2025/0294163 A1
(43) Pub. Date: Sep. 18, 2025

(54) IMAGE PROCESSING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: De CAI, Shenzhen (CN)

(73) Assignee: TENCENT TECHNOLOGY (SHENZHEN) COMPANY LIMITED, Shenzhen (CN)

(21) Appl. No.: 19/223,314

(22) Filed: May 30, 2025

Related U.S. Application Data
(63) Continuation of application No. PCT/CN2024/087137, filed on Apr. 11, 2024.

(30) Foreign Application Priority Data
Jun. 8, 2023 (CN) 202310674427.9

(51) Int. Cl. H04N 19/154; G06T 5/70; H04N 19/132; H04N 19/172; H04N 19/86

(52) U.S. Cl. CPC H04N 19/154; G06T 5/70; H04N 19/132; H04N 19/172; H04N 19/86; G06T 2207/10016

(57) ABSTRACT

An image processing method of an electronic device includes performing feature extraction on a compressed image to obtain a compression feature map of the compressed image; performing reconstruction on the compression feature map to obtain a reconstruction feature map of the compressed image; performing quality factor (QF) prediction on the compression feature map to obtain a QF of the compressed image; and generating a denoised compressed image having compression noise reduced or removed from the compressed image by performing denoising on the reconstruction feature map based on the QF.

### CROSS-REFERENCE TO RELATED APPLICATIONS

This application is a continuation application of International Application No. PCT/CN2024/087137 filed on Apr. 11, 2024, which claims priority to Chinese Patent Application No. 202310674427.9 filed with the China National Intellectual Property Administration on Jun. 8, 2023, the disclosures of each being incorporated by reference herein in their entireties.

### FIELD

The disclosure relates to artificial intelligence (AI) technologies, and to an image processing method and apparatus, an electronic device, a computer-readable storage medium, and a computer program product.

### BACKGROUND

Artificial intelligence (AI) is a computer science-related technology, which includes the study of design principles and implementation methods of various intelligent machines, to enable the machines to have functions of sensing, reasoning, and decision-making. AI technology covers a wide range of fields, such as natural language processing technology, machine learning, and deep learning. With the development of these technologies, AI is increasingly applied to more fields and plays an increasingly important role across various disciplines.

Image processing is one example application of AI technology. With the continuous development of video technologies, video quality requirements continue to increase. However, transmission, storage, and processing costs of high-resolution videos may be significant, which limits the development of video applications. Therefore, video compression technologies have emerged to help reduce storage and transmission costs of video data. Notwithstanding, compressed video often results in a significant reduction in image quality.

### SUMMARY

Provided are an image processing method and apparatus, an electronic device, a computer-readable storage medium, and a computer program product, which may remove compression noise in a compressed image which may improve image quality.

According to an aspect of the disclosure, an image processing method, for an electronic device includes performing feature extraction on a compressed image to obtain a compression feature map of the compressed image; performing reconstruction on the compression feature map to obtain a reconstruction feature map of the compressed image; performing quality factor (QF) prediction on the compression feature map to obtain a QF of the compressed image; and generating a denoised compressed image having compression noise reduced or removed from the compressed image by performing denoising on the reconstruction feature map based on the QF.

According to an aspect of the disclosure, an image processing apparatus includes, at least one memory configured to store computer program code; and at least one processor configured to read the program code and operate as instructed by the program code, the program code includes extraction code configured to cause at least one of the at least one processor to perform feature extraction on a compressed image to obtain a compression feature map of the compressed image; reconstruction code configured to cause at least one of the at least one processor to perform reconstruction on the compression feature map to obtain a reconstruction feature map of the compressed image; prediction code configured to cause at least one of the at least one processor to perform QF prediction on the compression feature map to obtain a QF of the compressed image; and denoising code configured to cause at least one of the at least one processor to generate a denoised compressed image having compression noise reduced or removed from the compressed image by performing denoising on the reconstruction feature map based on the QF.

According to an aspect of the disclosure, a non-transitory computer-readable storage medium, storing computer code which, when executed by at least one processor, causes the at least one processor to at least perform feature extraction on a compressed image to obtain a compression feature map of the compressed image; perform reconstruction on the compression feature map to obtain a reconstruction feature map of the compressed image; perform quality factor (QF) prediction on the compression feature map to obtain a QF of the compressed image; and generate a denoised compressed image having compression noise reduced or removed from the compressed image by performing denoising on the reconstruction feature map based on the QF.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an application scenario of an image processing system according to some embodiments.

FIG. 2 is a schematic structural diagram of an electronic device for image processing according to some embodiments.

FIG. 3A is a first schematic flowchart of an image processing method according to some embodiments.

FIG. 3B is a second schematic flowchart of an image processing method according to some embodiments.

FIG. 3C is a third schematic flowchart of an image processing method according to some embodiments.

FIG. 3D is a fourth schematic flowchart of an image processing method according to some embodiments.

FIG. 3E is a fifth schematic flowchart of an image processing method according to some embodiments.

FIG. 3F is a sixth schematic flowchart of an image processing method according to some embodiments.

FIG. 3G is a schematic structural diagram of a reconstruction network according to some embodiments.

FIG. 3H is a schematic diagram of a denoising process according to some embodiments.

FIG. 4 is a seventh schematic flowchart of an image processing method according to some embodiments.

FIG. 5 is a schematic structural diagram of a dynamic denoising network according to some embodiments.

FIG. 6 is a schematic flowchart of a super-resolution algorithm according to some embodiments.

FIG. 7 is a schematic flowchart of video compression according to some embodiments.

FIG. 8 is a schematic flowchart of an image processing method according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In the following description, a term “first/second” involved is used for distinguishing between similar objects and does not represent an order of objects. “First/second” may be transposed for an order or a sequence when allowed, so that some embodiments described herein can be implemented in an order other than those illustrated or described herein.

In the following description, the involved expression “some embodiments” describes subsets of all some embodiments, but the expression “some embodiments” may be the same subset or different subsets of all some embodiments, and may be combined with each other without conflict.

Unless otherwise defined, meanings of all technical and scientific terms used are the same as those understood by a person skilled in the art to which the disclosure belongs. The terms used in the disclosure are intended to describe objectives of some embodiments, and are not intended to limit the disclosure.

Before some embodiments are further described in detail, a description is made on nouns and terms in some embodiments, and the nouns and terms in some embodiments are applicable to the following explanations.

1) Downsampling: An image is downscaled to enable the image to fit a fixed size, and a resolution of the image is reduced. For an image I with a size of M*N, downsampling is performed on the image I by a factor of s, to obtain a resolution image with a size of (M/s)*(N/s), where s is a common divisor of M and N. For example, for an image in a matrix form, an image in an s*s window of an original image is converted into a pixel, and a value of the pixel is a mean value of all pixels in the s*s window.

2) Upsampling: An image is upscaled to enable the image to fit a fixed size, and a resolution of the image is increased. For image upscaling, an interpolation method may be adopted. Based on original image pixels, a new pixel is inserted between pixel points through an appropriate interpolation algorithm.

3) Quality factor (QF): The QF in image compression refers to a compression ratio, which represents a ratio of a size of an original image to a size of a compressed image. The size of the original image is a size of an uncompressed image file, and the size of the compressed image is a size of an image file obtained through compression algorithm processing. In digital image processing, a QF is one of important indicators for measuring compression efficiency. A larger QF indicates a better compression effect. A size of an image file is significantly reduced through a compression algorithm. For example, the QF is between 1 and 100, and a larger value indicates a better compression effect. A larger QF is more likely to cause image distortion or loss of some details. A relationship between a compression effect and image quality may be weighed in practical application.

4) Modulation factor: The modulation factor is a parameter for measuring image quality, which may be configured during image compression for describing a change in a degree of distortion of an image before and after compression. During the image compression, the modulation factor represents a relative relationship between quality of a compressed image and quality of an original image. Through a change in the modulation factor, a balance between the quality of the compressed image and a compression rate may be adjusted, to obtain a compressed image that better meets a requirement. A value range of the modulation factor may be between 0 and 1, where I represents quality of an original image, and 0 represents a completely distorted image. In different compression algorithms, the modulation factor may be calculated through different methods, but objectives of the compression algorithms are to minimize data loss during compression while ensuring the image quality.

Some embodiments provide an image processing method and apparatus, an electronic device, a computer-readable storage medium, and a computer program product, which can effectively remove compression noise in a compressed image to improve image quality.

The image processing method provided in some embodiments may be implemented by a terminal/server alone, or may be implemented collaboratively by a terminal and a server. For example, the terminal independently performs the image processing method described below, or the terminal transmits an image processing request to the server, and the server performs the image processing method based on the received image processing request.

An electronic device for image processing provided in some embodiments may be various types of terminal devices or servers. The server may be an independent physical server, or may be a server cluster formed by a plurality of physical servers or a distributed system, and may further be a cloud server providing cloud computing services such as cloud service, a cloud database, cloud computing, a cloud function, cloud storage, a network service, cloud communication, a middleware service, a domain name service, a security service, a content delinetwork (CDN), a big data and artificial intelligence (AI) platform. The terminal may be a notebook computer, a tablet computer, a desktop computer, a set-top box, a mobile device (for example, a mobile phone, a portable music player, a personal digital assistant, a dedicated message device, a portable game device, an on-board device), a smart phone, a smart speaker, a smart watch, a smart TV, an on-board terminal, and other various types of user terminals, but is not limited thereto. The terminal and the server may be directly or indirectly connected through wired or wireless communication, which is not limited herein in some embodiments.

The server is used as an example. For example, the server may be a server cluster deployed in the cloud, and opens AI as a Service (AIaaS) to users. An AIaaS platform splits several common AI services, and provides an independent or packaged service on the cloud. Such a service mode is similar to that of an AI theme mall. All users may access, through an application programming interface, and use one or more AI services provided by using the AIaaS platform.

For example, one of the AI cloud services may be an image processing service, for example, a cloud server is encapsulated with an image processing program provided in some embodiments. A user calls an image processing service in a cloud service through a terminal (having a client such as a video client run thereon), so that a server deployed on the cloud calls an encapsulated image processing program to: perform feature extraction on a compressed image, to obtain a compression feature map of the compressed image; perform reconstruction on the compression feature map to obtain a reconstruction feature map of the compressed image; perform QF prediction on the compression feature map to obtain a QF of the compressed image; and perform denoising on the reconstruction feature map based on the QF, to obtain a denoised compressed image, to effectively remove compression noise in the compressed image and improve image quality.

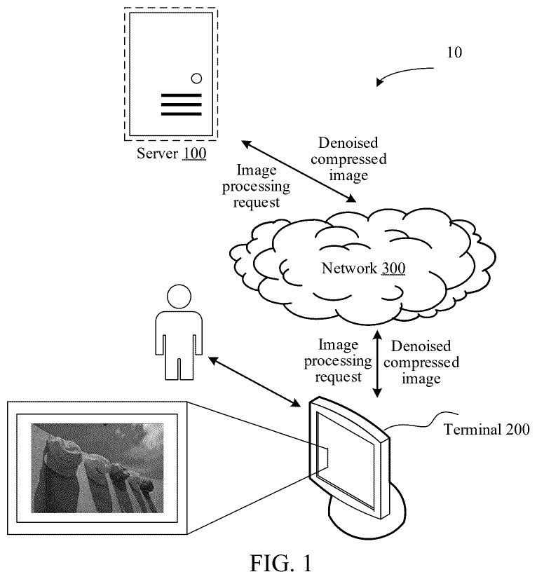

FIG. 1 is a schematic diagram of an application scenario of an image processing system 10 according to some embodiments. A terminal 200 is connected to a server 100 through a network 300. The network 300 may be a wide area network, a local area network, or a combination thereof.

The terminal 200 (having a client run thereon, for example, a call client or a video client) may be configured to obtain an image processing request. For example, a user opens a video client through the terminal, and the terminal automatically obtains an image processing request (including any compressed image in a video).

In some embodiments, an image processing plug-in may be implanted in the client running in the terminal, which is configured to implement the image processing method locally on the client. For example, the terminal 200 calls the image processing plug-in to implement the image processing method, and performs feature extraction on a compressed image, to obtain a compression feature map of the compressed image; performs reconstruction on the compression feature map to obtain a reconstruction feature map of the compressed image; performs QF prediction on the compression feature map to obtain a QF of the compressed image; and performs denoising on the reconstruction feature map based on the QF, to obtain a denoised compressed image, to effectively remove compression noise in the compressed image and improve image quality.

In an example, for a video application, a client obtains any compressed image in a video, dynamically determines a QF through an image processing method, and denoises all compressed images in the video through the QF, thereby obtaining a denoised compressed image with the same quality as possible, to obtain a high-quality video and improve viewing experience of the user.

In some embodiments, after obtaining the image processing request, the terminal 200 calls an image processing interface (which may be provided in a cloud service form, for example, an image processing service) of the server 100, and the server 100 performs feature extraction on a compressed image, to obtain a compression feature map of the compressed image; performs reconstruction on the compression feature map to obtain a reconstruction feature map of the compressed image; performs QF prediction on the compression feature map to obtain a QF of the compressed image; and performs denoising on the reconstruction feature map based on the QF, to obtain a denoised compressed image, and transmits the denoised compressed image to the terminal 200 to respond to the image processing request, to effectively remove compression noise in the compressed image and improve image quality.

In an example, for an instant messaging application, after a user receives a compressed image transmitted by a friend, the server 100 dynamically determines a QF through an image processing method, and denoises all compressed images in a video through the QF, thereby obtaining a high-quality denoised compressed image and improve user experience.

In some embodiments, the terminal or the server may implement the image processing method provided in some embodiments by running various computer-executable instructions or computer programs. For example, the computer-executable instructions may be microprogram-level commands, machine instructions, or software instructions. The computer program may be a native program or a software module in an operating system, may be a native application (APP), for example, a program that may be installed in the operating system to run, such as a video application or an instant messaging application, or may be a mini program that can be embedded into any APP, for example a program that may be downloaded into a browser environment to run. The foregoing computer-executable instruction may be an instruction in any form, and the foregoing computer program may be an APP, a module, or a plug-in in any form.

In some embodiments, a plurality of servers may form a block chain. The server 100 is a node on the block chain, an information connection may exist between nodes in the blockchain, and information transmission may be performed between the nodes through the foregoing information connection. Data (for example, logic of image processing and the denoised compressed image) related to the image processing method provided in some embodiments may be stored in the blockchain.

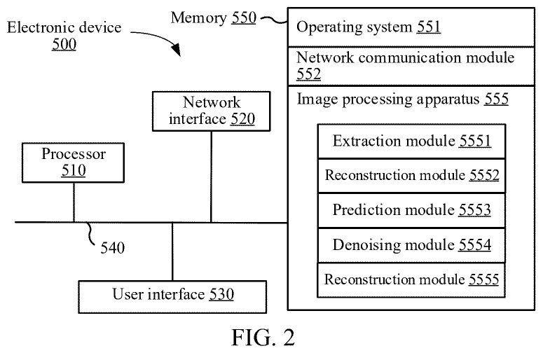

A structure of the electronic device for image processing provided in some embodiments is described below. FIG. 2 is a schematic structural diagram of an electronic device 500 for image processing according to some embodiments. An example in which the electronic device 500 is a terminal is used for description. The electronic device 500 for image processing shown in FIG. 2 includes at least one processor 510, a memory 550, at least one network interface 520, and a user interface 530. Various components in the electronic device 500 are coupled together through a bus system 540. The bus system 540 is configured to implement connection and communication between the components. In addition to a data bus, the bus system 540 further includes a power bus, a control bus, and a status signal bus. For clarity, various buses are marked as the bus system 540 in FIG. 2.

The processor 510 may be an integrated circuit chip with a signal processing capability, for example, a central processing unit (CPU), a digital signal processor (DSP), another programmable logic device, a discrete gate or a transistor logic device, or a discrete hardware component. The CPU may be a microprocessor, any processor, or the like.

The memory 550 includes a volatile memory or a non-volatile memory, or may include both the volatile memory and the non-volatile memory. The non-volatile memory may be a read-only memory (ROM). The volatile memory may be a random access memory (RAM). The memory 550 described in some embodiments is intended to include various types of memory. In some embodiments, the memory 550 includes one or more storage devices that are physically located away from the processor 510.

In some embodiments, the memory 550 can store data to support various operations. Examples of the data include a program, a module, and a data structure or a subset or a superset thereof. An exemplary description is given below.

An operating system 551 includes system programs configured to process various system services and perform hardware-related tasks, for example, a framework layer, a core library layer, and a driver layer, which are configured for implementing various services and process hardware-based tasks.

A network communication module 552 is configured to arrive at another electronic device through one or more (wired or wireless) network interfaces 520. Exemplary network interfaces 520 include a bluetooth interface, a wireless compatibility authentication (Wi-Fi) interface, a universal serial bus (USB) interface, and the like.

In some embodiments, the image processing apparatus provided in some embodiments may be implemented through software. The image processing apparatus provided in some embodiments may be provided as various software embodiments, including various forms such as an application program, software, a software module, a script, or code.

FIG. 2 shows an image processing apparatus 555 stored in a memory 550, which may be software in a form of a program, a plug-in, and the like, and includes a series of modules, including an extraction module 5551, a reconstruction module 5552, a prediction module 5553, a denoising module 5554, and a reconstruction module 5555. The modules are logical modules, and therefore may be arbitrarily combined or further split based on a function to be performed. A function of each module is to be described below.

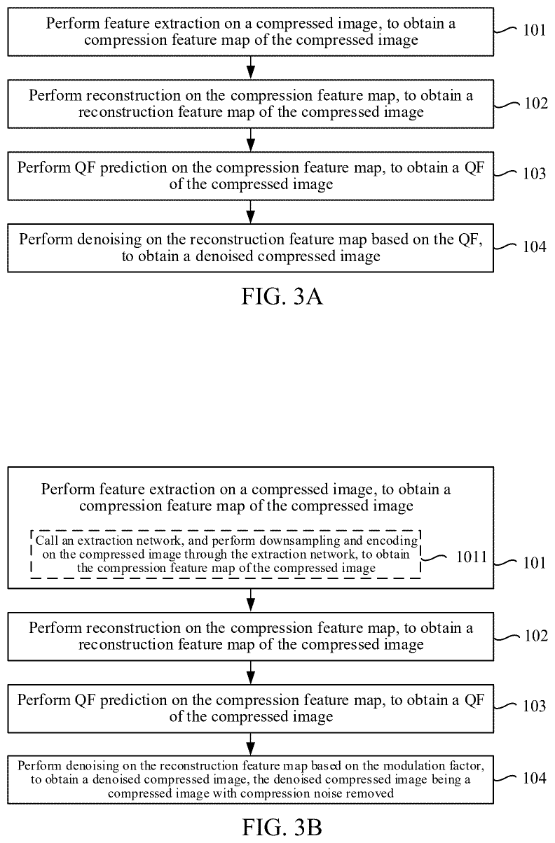

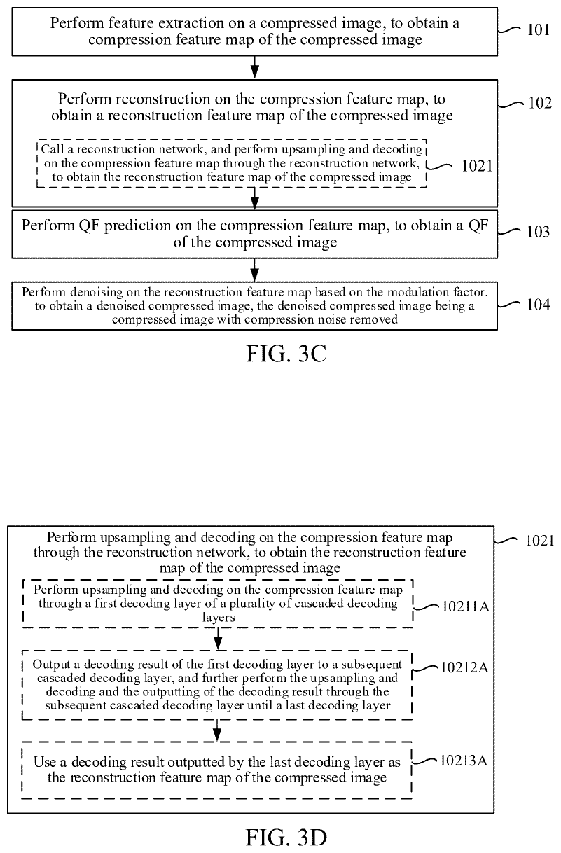

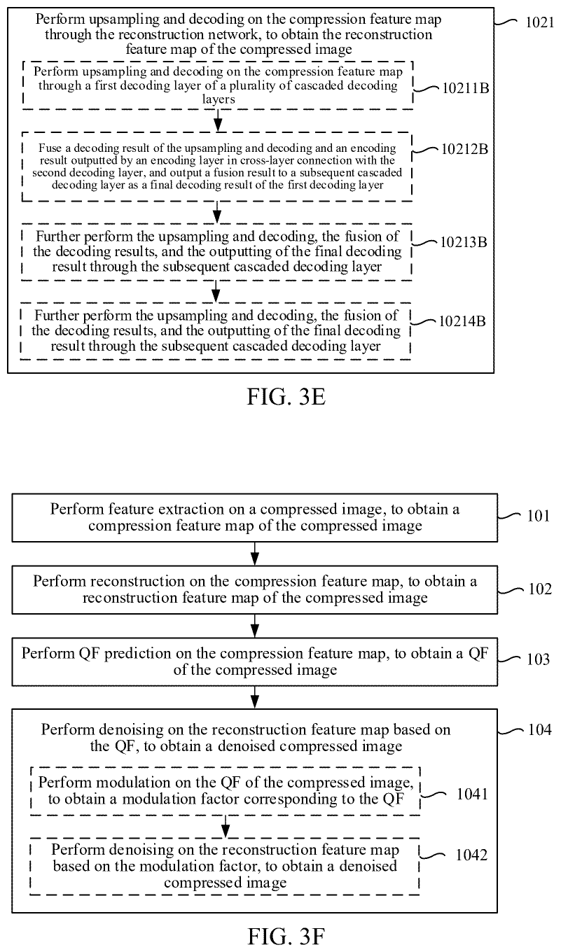

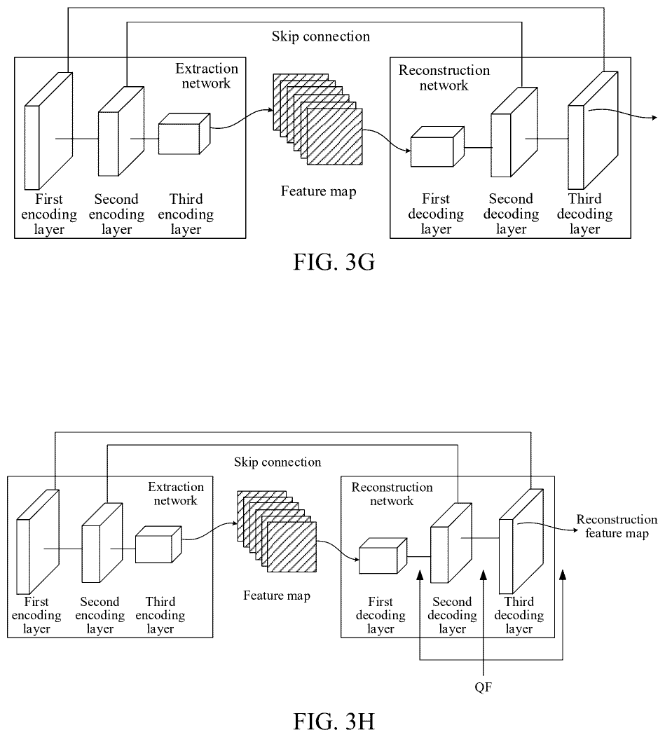

The image processing method provided in some embodiments may be implemented by various types of electronic devices, for example, a terminal, a server, or a combination thereof. FIG. 3A is a first schematic flowchart of an image processing method according to some embodiments. A description is provided based on operations shown in FIG. 3A.

In the following operations, a compressed image is an image compressed through a compression algorithm. Since different QFs produce different compression noise, images compressed through different QFs may introduce compression noise of different degrees, resulting in different quality of the compressed image. The compressed image may be an image frame in a video or an image sequence.

Operation 101: Perform feature extraction on a compressed image to obtain a compression feature map of the compressed image.

The compression feature map is a feature map related to a QF, and a representation form of the feature map may be a matrix, a vector, or the like.

FIG. 3B is a second schematic flowchart of an image processing method according to some embodiments. FIG. 3B shows that operation 101 in FIG. 3A may be implemented through operation 1011. In operation 1011, an extraction network is called, and downsampling and encoding are performed on the compressed image through the extraction network, to obtain a compression feature map of the compressed image.

Herein, the downsampling and encoding are performed on the compressed image through an AI technology, to extract the compression feature map from the compressed image through the downsampling and encoding. Some embodiments is not limited to a structural form of the extraction network. For example, the extraction network may be a deep neural network (NN) or a convolutional neural network. For example, downsampling and encoding are implemented by downsampling an image through an extraction network, to downsample image data (a compressed image) into a feature vector (a compressed image map).

In some embodiments, the extraction network includes a plurality of cascaded encoding layers. Operation 1011 may be implemented in the following manners: performing downsampling and encoding on the compressed image through a first encoding layer of the plurality of cascaded encoding layers; outputting an encoding result of the first encoding layer to a subsequent cascaded encoding layer, and further performing the downsampling and encoding and the outputting of the encoding result through the subsequent cascaded encoding layer until a last encoding layer; and using an encoding result output by the last encoding layer as the compression feature map of the compressed image.

Herein, features are extracted layer by layer (for example, cascaded downsampling and encoding) by extracting cascaded encoding layers in a network, to extract precise features related to a QF, so that accurate prediction can be performed subsequently based on a precise compression feature map.

In some embodiments, each encoding layer includes a plurality of cascaded convolutional layers and a downsampling layer. The downsampling and encoding performed on the compressed image through the first encoding layer of the plurality of cascaded encoding layers may be implemented in the following manners: performing cascaded convolution on the compressed image through the plurality of cascaded convolutional layers included in the first encoding layer, to obtain a convolution feature map of the compressed image; and performing downsampling on the convolution feature map of the compressed image through a downsampling layer included in the first encoding layer, to obtain an encoding result of the first encoding layer. A cascading manner of the plurality of cascaded encoding layers is similar to a cascading manner of the encoding layer.

In some embodiments, the further performing the downsampling and encoding and the outputting of the encoding result through the subsequent cascaded encoding layer may be implemented in the following manners: performing cascaded convolution on an encoding result output by an (i−1)^{th} encoding layer through a plurality of cascaded convolutional layers included in an i^{th} encoding layer, to obtain a convolution feature map of the i^{th} encoding layer; and performing downsampling on the convolution feature map of the i^{th} encoding layer through a downsampling layer included in the i^{th} encoding layer, to obtain an encoding result of the i^{th} encoding layer, and outputting the encoding result of the i^{th} encoding layer to an (i+1)^{th} encoding layer, i being an increasing positive integer, 1<i<N, and N being a total quantity of encoding layers. A cascading manner of the plurality of cascaded encoding layers is similar to a cascading manner of the encoding layer.

In some embodiments, performing downsampling and encoding through the last encoding layer may be implemented in the following manners: performing cascaded convolution on an encoding result output by an (N−1)^{th} encoding layer through a plurality of cascaded convolutional layers included in the last encoding layer, to obtain a convolution feature map of the last encoding layer; performing downsampling on the convolution feature map of the last encoding layer through a downsampling layer included in the last encoding layer, to obtain an encoding result of the last encoding layer; and using an encoding result output by the last encoding layer as the compression feature map of the compressed image. A cascading manner of the plurality of cascaded encoding layers is similar to a cascading manner of the encoding layer.

In the field of image processing, convolution is a basic technology for image processing. A convolution operation is a mathematical operation that involves “sliding” one function over another (an input) and “integrating” their product to generate a new function (for example, an output). The convolution may be configured for identifying a mode or a feature in an image. The extraction network that is an NN performs a convolution operation on a region (also referred to as a “convolution kernel”) of an image, to extract a feature of the image. The features may include an edge, texture, a color, and the like. Downsampling is also a basic technology for image processing, which is also referred to as spatial downsampling or skip connections, and refers to a reduction in a spatial size of an input while maintaining a feature pyramid structure. In the extraction network that is an NN, downsampling may involve performing a repetition or permutation operation on a matrix, so that a size of the matrix is smaller. This process allows a model to focus on local features rather than complete global information. Downsampling can further enhance the parallel processing capability of the model and improve calculation efficiency.

In some embodiments, two processes including convolution and downsampling are used together to extract a compression feature map of a compressed image. The convolution operation is configured for extracting a feature, and the downsampling is configured for reducing a spatial size of an image, thereby allowing the model to process a larger amount of input data. Such combination allows the model to capture local and global information of a compressed image while maintaining a processing speed and efficiency.

Operation 102: Perform reconstruction on the compression feature map to obtain a reconstruction feature map of the compressed image.

The reconstruction feature map is a to-be-denoised feature map reconstructed based on the compressed image, and a representation form of the feature map may be a matrix, a vector, or the like.

FIG. 3C is a third schematic flowchart of an image processing method according to some embodiments. FIG. 3C shows that operation 102 in FIG. 3A may be implemented through operation 1021. In operation 1021, a reconstruction network is called, and upsampling and decoding are performed on the compression feature map through the reconstruction network, to obtain a reconstruction feature map of the compressed image.

Herein, upsampling and decoding are performed on the compression feature map through an AI technology, to reconstruct the reconstruction feature map through upsampling and decoding. Some embodiments is not limited to a structural form of the reconstruction network. For example, the reconstruction network may be a deep NN or a convolutional NN. The upsampling and decoding are implemented by upsampling the feature map through the reconstruction network, to increase a resolution of the feature map.

FIG. 3D is a fourth schematic flowchart of an image processing method according to some embodiments. FIG. 3D shows that operation 1021 in FIG. 3C may be implemented through operation 10211A to operation 10213A. The reconstruction network includes a plurality of cascaded decoding layers. In operation 10211A, upsampling and decoding are performed on the compression feature map through a first decoding layer of the plurality of cascaded decoding layers. In operation 10212A, a decoding result of the first decoding layer is output to a subsequent cascaded decoding layer, and the upsampling and decoding are further performed and the decoding result is output through the subsequent cascaded decoding layer until a last decoding layer. In operation 10213A, a decoding result output by the last decoding layer is used as the reconstruction feature map of the compressed image.

Herein, reconstruction and restoration (for example, cascaded upsampling and decoding) are performed layer by layer through the cascaded decoding layers in the reconstruction network, to restore the same features as those of the compressed image, so that accurate modulation can be performed subsequently based on a precise QF.

In some embodiments, each decoding layer includes a plurality of cascaded convolutional layers and an upsampling layer. Operation 10211A may be implemented in the following manners: performing cascaded convolution on the compression feature map through the plurality of cascaded convolutional layers included in the first decoding layer, to obtain a convolution feature map of the compression feature map; and performing upsampling on the convolution feature map through an upsampling layer included in the first decoding layer, to obtain a decoding result of the first decoding layer. A cascading manner of the plurality of cascaded decoding layers is similar to a cascading manner of the decoding layer.

In some embodiments, each decoding layer includes a plurality of cascaded convolutional layers and an upsampling layer. Operation 10212A may be implemented in the following manners: outputting the decoding result of the first decoding layer to a subsequent cascaded decoding layer, and performing cascaded convolution on a decoding result output by a (j−1)^{th} decoding layer through a plurality of cascaded convolutional layers included in a j^{th} decoding layer, to obtain a convolution feature map of the j^{th} decoding layer; and performing upsampling on the convolution feature map of the j^{th} decoding layer through an upsampling layer included in the j^{th} decoding layer, to obtain a decoding result of the j^{th} decoding layer, and outputting the decoding result of the j^{th} decoding layer to a (j+1)^{th} decoding layer, j being an increasing positive integer, 1<j<M, and M being a total quantity of decoding layers. A cascading manner of the plurality of cascaded decoding layers is similar to a cascading manner of the decoding layer.

In some embodiments, each decoding layer includes a plurality of cascaded convolutional layers and an upsampling layer. Operation 10213A may be implemented in the following manners: performing cascaded convolution on a decoding result output by an (M−1)^{th} decoding layer through a plurality of cascaded convolutional layers included in the last decoding layer, to obtain a convolution feature map of the last decoding layer; and performing upsampling on the convolution feature map of the last decoding layer through an upsampling layer included in the last decoding layer, to obtain a decoding result of the last decoding layer, and using the decoding result output by the last decoding layer as the reconstruction feature map of the compressed image. A cascading manner of the plurality of cascaded decoding layers is similar to a cascading manner of the decoding layer.

In the field of image processing, convolution and upsampling in an NN play a key role in constructing the reconstruction network. The convolution is the core of the reconstruction network, which performs local calculation on an input image through a filter (also referred to as a convolution kernel), to extract a local feature of the image. The convolution kernel slides on the image (also referred to as scanning), and a feature map is generated through each calculation. These feature maps represent abstract features of different levels in an image, ranging from raw pixels to more complex shapes and textures. The convolution operation helps a model automatically learn a capability of extracting important features from an input image. Upsampling is another important operation in the reconstruction network, which is configured for increasing a spatial dimension, for example, increasing a height and a width of an image. This is contrary to the downsampling. The downsampling is to reduce the spatial dimension. The upsampling may be implemented in a plurality of manners, for example, transposed convolution. The transposed convolution enables a size of the output image to be larger than that of the input image through a convolution kernel. This operation is used in the NN to restore an image size, maintain spatial information during feature fusion, and reconstruct image details during image generation.

The upsampling in some embodiments helps restore details in a deeper layer of a network, which may be useful in some complex image reconstruction tasks. Convolution and upsampling in the reconstruction network play an important role in extracting and reconstructing features in the NN for image processing. Through these operations, a network can learn complex feature representation from an original image, to accurately reconstruct image details.

FIG. 3E is a fifth schematic flowchart of an image processing method according to some embodiments. FIG. 3E shows that operation 1021 in FIG. 3C may be implemented through operation 10211B to operation 10213B. When the extraction network includes the plurality of cascaded encoding layers, the reconstruction network includes the plurality of cascaded decoding layers, and a cross-layer connection exists between each of the encoding layers and each of the decoding layers. In operation 10211B, upsampling and decoding are performed on the compression feature map through a first decoding layer of the plurality of cascaded decoding layers. In operation 10212B, a decoding result of the upsampling and decoding and an encoding result output by an encoding layer in cross-layer connection with the second decoding layer are fused, and a fusion result is output to a subsequent cascaded decoding layer as a final decoding result of the first decoding layer. In operation 10213B, the upsampling and decoding, the fusion of the decoding results, and the outputting of the final decoding result are further performed through the subsequent cascaded decoding layer. In operation 10214B, a decoding result output by the last decoding layer is used as the reconstruction feature map of the compressed image.

Herein, outputs of the encoding layers with cross-layer connections (for example, skip connections) are fused through the cascaded decoding layers in the reconstruction network, and reconstructed and restored layer by layer, to restore the same features as those of the compressed image, so that accurate modulation can be performed subsequently based on a precise QF.

As shown in FIG. 3G, the extraction network includes three cascaded encoding layers, and the reconstruction network includes three cascaded decoding layers. A cross-layer connection exists between a first encoding layer and a third decoding layer, and a cross-layer connection exists between the second encoding layer and the second decoding layer. Upsampling and decoding are performed on the compression feature map through the first decoding layer to obtain a decoding result of the first decoding layer. The decoding result of the upsampling and decoding and the encoding result output by the second encoding layer in cross-layer connection with the second decoding layer are fused, and a fusion result is output to the second decoding layer as a final decoding result of the first decoding layer. Upsampling and decoding are performed on the final decoding result of the first decoding layer through the second decoding layer, to obtain a decoding result of the second decoding layer, the decoding result of the upsampling and decoding and an encoding result output by the first encoding layer in cross-layer connection with the third decoding layer are fused, and a fusion result is output to the third decoding layer as a final decoding result of the second decoding layer. Upsampling and decoding are performed on a final decoding result of the second decoding layer through the second decoding layer, and the decoding result of the upsampling and decoding is used as the reconstruction feature map of the compressed image.

In some embodiments, each decoding layer includes a plurality of cascaded convolutional layers and an upsampling layer. Operation 10211B may be implemented in the following manners: performing cascaded convolution on the compression feature map through the plurality of cascaded convolutional layers included in the first decoding layer, to obtain a convolution feature map of the compression feature map; and performing upsampling on the convolution feature map through an upsampling layer included in the first decoding layer, to obtain a decoding result of the first decoding layer.

In some embodiments, operation 10212B may be implemented in the following manner: performing element-by-element addition on the decoding result of the upsampling and decoding and an encoding result output by an encoding layer in cross-layer connection with the second decoding layer, and outputting an addition result to a subsequent cascaded decoding layer as a final decoding result of the first decoding layer; or concatenating the decoding result of the upsampling and decoding and an encoding result output by an encoding layer in cross-layer connection with the second decoding layer, and outputting a concatenation result to a subsequent cascaded decoding layer as a final decoding result of the first decoding layer.

In some embodiments, each decoding layer includes a plurality of cascaded convolutional layers and an upsampling layer. Operation 10213B may be implemented in the following manners: performing cascaded convolution on a final decoding result output by a (j−1)^{th} decoding layer through a plurality of cascaded convolutional layers included in a j^{th} decoding layer, to obtain a convolution feature map; and performing upsampling on the convolution feature map through an upsampling layer included in the j^{th} decoding layer, to obtain a decoding result of the j^{th} decoding layer, fusing the decoding result of the j^{th} decoding layer and an encoding result output by an encoding layer in cross-layer connection with a (j+1)^{th} decoding layer, and outputting a fusion result to the (j+1)^{th} decoding layer as a final decoding result of the j^{th} decoding layer, j being an increasing positive integer, 1<j<M, and M being a total quantity of decoding layers.

In some embodiments, each decoding layer includes a plurality of cascaded convolutional layers and an upsampling layer. Operation 10214B may be implemented in the following manners: performing cascaded convolution on a final decoding result output by an (M−1)^{th} decoding layer through a plurality of cascaded convolutional layers included in the last decoding layer, to obtain a convolution feature map of the last decoding layer; and performing upsampling on the convolution feature map of the last decoding layer through an upsampling layer included in the last decoding layer, to obtain a decoding result of the last decoding layer, and using the decoding result output by the last decoding layer as the reconstruction feature map of the compressed image.

Operation 103: Perform QF prediction on the compression feature map to obtain a QF of the compressed image.

Herein, in combination with the AI technology, QF prediction is performed on the compression feature map through a prediction network, to obtain the QF of the compressed image. Some embodiments is not limited to a structural form of the prediction network. For example, the prediction network may be an NN such as a deep NN or a convolutional NN.

In some embodiments, operation 103 may be implemented in the following manners: performing full connection of the QF on the compression feature map, to obtain a second full connection feature; and performing activation of the QF on the second full connection feature, to obtain the QF of the compressed image.

Herein, the prediction network may include a plurality of cascaded fully connected layers and an activation layer. The full connection of the QF is performed on the compression feature map through a cascaded fully connected layer of the prediction network, to obtain a second full connection feature, and the activation of the QF is performed on the second full connection feature through an activation layer of the prediction network, to obtain the QF of the compressed image.

In the field of image processing, a fully connected layer and an activation function are important parts of the NN. The fully connected layer is an important layer type in the NN. In the fully connected layer, each neuron is connected to each neuron in a previous layer. The fully connected layer is configured to multiply outputs of all neurons in the previous layer through weights and add a bias to obtain an output of a current layer. In an image processing task, the fully connected layer is configured to integrate and classify extracted features through full connection. The fully connected layer provides characteristics of a large number of parameters and a strong expression ability in the NN, which helps learn complex patterns and relationships in data. The activation function is a non-linear function in the NN, which is configured for introducing a non-linear feature to an output of a neuron. For example, the activation function may be a hyperbolic tangent function (Sigmoid) or a rectified linear unit (ReLU). In the field of image processing, the activation function performs well in deep learning, which can accelerate convergence, reduce training difficulty, and avoid a problem of gradient disappearance. The activation function can further improve non-linear expression ability of the network, and help the network better fit complex data patterns.

In some embodiments, the full connection of the QF is performed on the compression feature map through the fully connected layer, to obtain a second full connection feature, and activation of the QF is performed on the second full connection feature through the activation function, to obtain an accurate QF of the compressed image. The fully connected layer is responsible for learning a complex relationship between features, and the activation function helps the network introduce a non-linear characteristic, thereby improving the expression capability of the network. Through reasonable design and configuration of the two components, a prediction network with a better effect may be constructed, to accurately predict a QF of a compressed image.

Operation 104: Perform denoising on the reconstruction feature map based on the QF, to obtain a denoised compressed image, the denoised compressed image being an image after compression noise is removed from the compressed image.

Herein, since different QFs may produce different compression noise for the compressed image, images compressed through different QFs may introduce compression noise of different degrees, resulting in different quality of the compressed image. Denoising is performed on the reconstruction feature map through the QF, so that the compression noise in the compressed image can be accurately removed, thereby improving quality of the denoised compressed image, and improving definition of the denoised compressed image.

In some embodiments, when a reconstruction network for reconstruction includes a plurality of cascaded decoding layers, and a reconstruction feature map is obtained through cascaded upsampling and decoding, denoising is performed, based on the QF, on a decoding result output by each decoding layer, to obtain a denoised decoding result output by each decoding layer, and the denoised decoding result output by each decoding layer is used as an input of a next decoding layer.

Herein, denoising is performed on the decoding result output by each decoding layer through the QF, to implement denoising layer by layer, thereby achieving a more accurate denoising effect. In some embodiments, the QF may be multiplied by the decoding result output by each decoding layer, to achieve a denoising effect. Modulation may be further performed on the QF of the compressed image, to obtain a modulation factor corresponding to the QF, and denoising is performed, based on the modulation factor, on a decoding result output by each decoding layer, to obtain a denoised decoding result output by each decoding layer. The modulation factor is related to the compression noise, and is configured for more precisely removing the compression noise in the image. Through modulation of the QF, a relationship between image quality and the QF may be balanced based on an actual requirement, thereby obtaining a denoised compressed image that better meets the requirement.

In some embodiments, when the extraction network includes a plurality of cascaded encoding layers, the reconstruction network includes a plurality of cascaded decoding layers, and a cross-layer connection exists between each of the encoding layers and each of the decoding layers. When the reconstruction feature map is obtained through cascaded upsampling and decoding and fusion of decoding results, denoising is performed on a final decoding result output by each decoding layer based on the QF, to obtain a denoised decoding result output by each decoding layer, and the denoised decoding result output by each decoding layer is used as an input of a next decoding layer.

Herein, denoising is performed on the final decoding result output by each decoding layer through the QF, to implement denoising layer by layer, thereby achieving a more accurate denoising effect. In some embodiments, the QF may be multiplied by the decoding result output by each decoding layer, to achieve a denoising effect. Modulation may be further performed on the QF of the compressed image, to obtain a modulation factor corresponding to the QF, and denoising is performed, based on the modulation factor, on a decoding result output by each decoding layer, to obtain a denoised decoding result output by each decoding layer. The modulation factor is related to the compression noise, and is configured for more precisely removing the compression noise in the image. Through modulation of the QF, a relationship between image quality and the QF may be balanced based on an actual requirement, thereby obtaining a denoised compressed image that better meets the requirement.

As shown in FIG. 3H, the extraction network includes three cascaded encoding layers, the reconstruction network includes three cascaded decoding layers, a cross-layer connection exists between the first encoding layer and the third decoding layer, and a cross-layer connection exists between the second encoding layer and the second decoding layer. Denoising is performed on a final decoding result of the first decoding layer and a final decoding result of the second decoding layer through the modulation factor.

FIG. 3F is a sixth schematic flowchart of an image processing method according to some embodiments. FIG. 3F shows that operation 104 in FIG. 3A may be implemented through operation 1041 to operation 1042.

In operation 1041, modulation is performed on the QF of the compressed image, to obtain a modulation factor corresponding to the QF.

Herein, in combination with the AI technology, modulation (for example, non-linear mapping) is performed on the QF of the compressed image through a control network, to obtain a modulation factor corresponding to the QF. Some embodiments is not limited to a structural form of the control network. For example, the control network may be a deep NN or a convolutional NN. The modulation factor is related to the compression noise, and is configured for more accurately removing the compression noise in the image.

In some embodiments, operation 1041 may be implemented in the following manners: performing full connection of the modulation factor on the QF of the compressed image, to obtain a first full connection feature; and performing activation of the modulation factor on the first full connection feature, to obtain the modulation factor corresponding to the QF.

Herein, the control network may include a plurality of cascaded fully connected layers and an activation layer. The full connection of the modulation factor is performed on the QF of the compressed image through a cascaded fully connected layer of the control network, to obtain a second full connection feature, and the activation of the modulation factor is performed on the second full connection feature through the activation layer of the control network, to obtain the modulation factor corresponding to the QF.

In some embodiments, the full connection of the modulation factor is performed on the QF of the compressed image through a fully connected layer, to obtain a first full connection feature, and the activation of the modulation factor is performed on the first full connection feature through the activation layer, to obtain an accurate modulation factor. The fully connected layer is responsible for learning a complex relationship between features, and the activation function helps the network introduce a non-linear characteristic, thereby improving the expression capability of the network. Through reasonable design and configuration of the two components, a control network with a better effect may be constructed, to accurately predict the modulation factor.

In operation 1042, denoising is performed on the reconstruction feature map based on the modulation factor, to obtain a denoised compressed image.

In some embodiments, the modulation factor includes a first factor (for example, Y) and a second factor (for example, B). Operation 1042 may be implemented in the following manners: multiplying the reconstruction feature map by the first factor, to obtain a product result; and adding the product result and the second factor, to obtain the denoised compressed image.

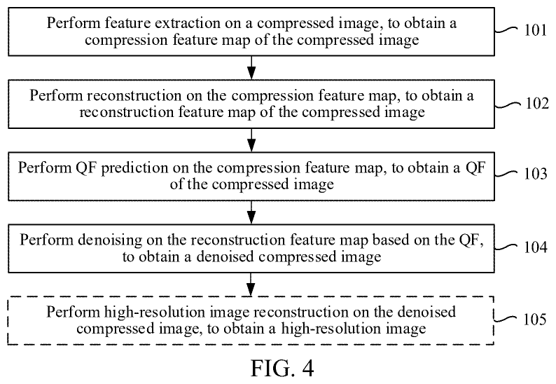

FIG. 4 is a seventh schematic flowchart of an image processing method according to some embodiments. FIG. 4 shows that FIG. 3A further includes operation 105. In operation 105, high-resolution image reconstruction is performed on the denoised compressed image, to obtain a high-resolution image.

Herein, the high-resolution image reconstruction is configured for reconstruction of a low-resolution image, to reconstruct a high-resolution image. For example, the high-resolution image reconstruction may be simple upsampling, and upsampling is performed on the denoised compressed image through a convolutional layer in an NN, to obtain a high-resolution image. Compared with the denoised compressed image as the low-resolution image, an image obtained after high-resolution image reconstruction is performed on the denoised compressed image is a high-resolution image.

The high-resolution image reconstruction includes a super-resolution technology (for example, a process of increasing the resolution of an image through hardware or software, and obtaining a high-resolution image through a series of low-resolution images). The super-resolution technology can improve definition and details of the image, for example, a deep learning-based super-resolution algorithm. Through the algorithm, a denoised compressed image is input into a deep NN, and reconstruction (for example, upsampling) is performed through the deep NN, to obtain a high-resolution image. Some embodiments is not limited to a form of a super-resolution algorithm, for example, a video super-resolution (VSR) algorithm, a basic deep learning video super-resolution algorithm (basicVSR), or a compression-informed video super-resolution model (COMISR).

In some embodiments, operation 105 may be implemented in the following manners: determining an adjacent image of the denoised compressed image, the adjacent image being a denoised compressed image adjacent to the denoised compressed image in an image sequence; performing feature extraction on the denoised compressed image and the adjacent image, to obtain a first feature of the denoised compressed image and a second feature of the adjacent image; performing fusion on the first feature and the second feature, to obtain a fused feature of the denoised compressed image; and performing reconstruction on the fused feature of the denoised compressed image, to obtain the high-resolution image.

The fusion may be performing element-by-element addition on the first feature and the second feature, and using an addition result as a fused feature of the denoised compressed image; or performing concatenation on the first feature and the second feature, and using a concatenation result as the fused feature of the denoised compressed image. The feature processing may be an upsampling operation. For a fused feature of H*W*C, a feature map of Hs*Ws*3 is finally obtained through the upsampling operation, s representing an upsampling factor, and 3 representing an RGB channel of a final output.

For example, the foregoing super-resolution technology is applied to the denoised compressed image. An adjacent image of the denoised compressed image is first determined, the adjacent image being a denoised compressed image adjacent to the denoised compressed image in an image sequence. Then feature extraction is performed on the denoised compressed image through the NN model, to obtain a first feature of the denoised compressed image, and feature extraction is performed on the adjacent image through the neural network model, to obtain a second feature of the adjacent image. Concatenation is performed on the first feature and the second feature, and a concatenation result is used as the fused feature of the denoised compressed image. Finally, reconstruction is performed on the fused feature of the denoised compressed image, to obtain a super-resolution image. The super-resolution image is a high-resolution image having a resolution greater than that of the denoised compressed image.

Exemplary application of some embodiments in an actual application scenario is to be described.

Some embodiments may be applied to various compression scenarios, for example, a compressed video super-resolution scenario. Video super-resolution may be widely applied to online and offline content playback, live streaming and on-demand scenarios, and fields such as old film restoration and real time communication (RTC) super-resolution. Further research and exploration in the foregoing fields may be performed for researchers. The application may also be user-oriented and integrated into a local end to perform video super-resolution, thereby improving picture quality of video content and improving smoothness of the video. The application fields of the compressed video super-resolution technology include, but are not limited to, video conferencing, video advertising, video live streaming, video on-demand, virtual reality, augmented reality, and the like. The technology may improve video quality, reduce bandwidth requirements, and improve data transmission efficiency, and is widely applied to fields such as e-commerce, medical treatment, education, and entertainment.

With the continuous development of video technology, people have an increasingly high requirement for video quality. Transmission, storage, and processing costs of high-resolution videos may be relatively high, which limits the development of video applications. Video compression technologies emerge to reduce storage and transmission costs of video data. Video compression often causes problems such as loss of image details and resolution reduction, which is unacceptable for some applications that may use high-resolution video.

A super-resolution technology is adopted in some embodiments, which is intended to reconstruct a high-resolution video from a low-resolution video. In a compressed video super-resolution technology, not only may a target compression rate of a video be maintained, but also details and resolution from an original video may be targeted for restoration. In some embodiments, a QF of image frames after video compression is analyzed dynamically, and compression noise corresponding to different compression degrees is reduced, to obtain image frames with the same quality as possible, thereby improving quality of a video reconstructed through a super-resolution video algorithm.

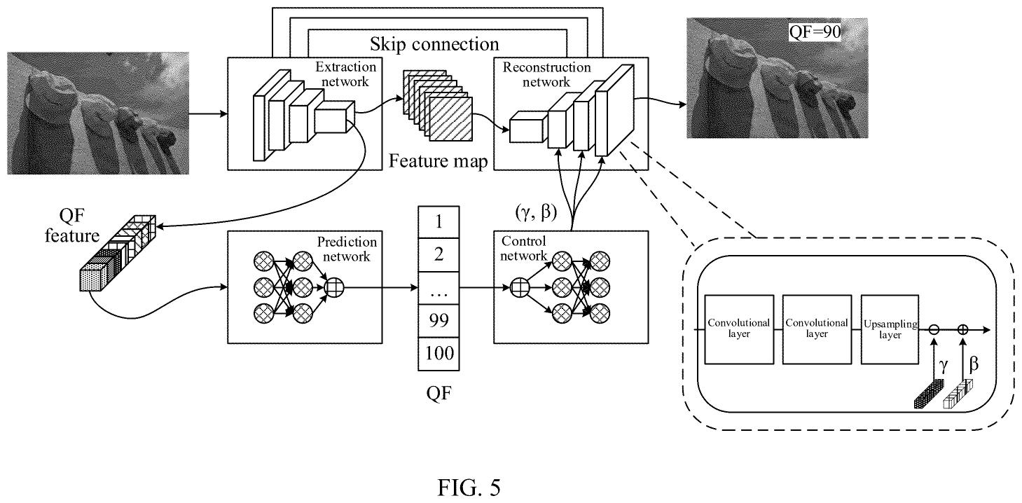

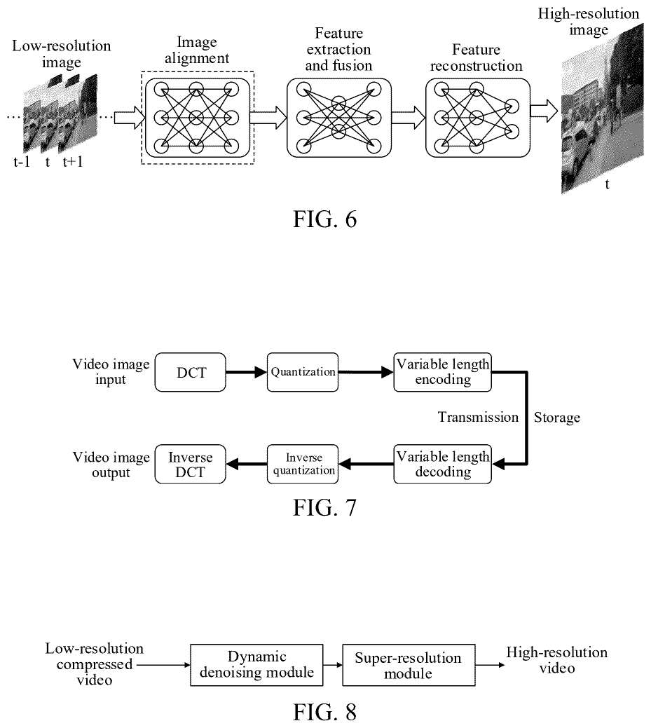

A process of removing compression noise based on a QF is explained and described below with reference to FIG. 5 to FIG. 6.

In some embodiments, a high-bitrate video may be compressed into a low-bitrate video through a video compression algorithm, to facilitate transmission and storage. The video compression algorithm includes two operations: spatial domain compression and frequency domain compression. In the spatial domain compression, a data volume of an image is reduced by removing redundant information and reducing precision, for example, discrete cosine transform (DCT) and wavelet transform (WT). Through these methods, the image is converted into another representation form, to compress a video signal. As shown in FIG. 7, an input video image is first transformed through DCT on an encoder side, then quantization is performed on the transformed video image, then variable length encoding is performed on a quantization result, and the encoding result is transmitted and stored. Variable length decoding is first performed on a received encoding result on a decoder side, then inverse quantization is performed on a decoding result, and finally inverse discrete cosine transform (IDCT) is performed on an inverse quantization result, to obtain an output of the video image. In the frequency domain compression, a high-frequency part may be removed to further reduce a data volume. A frequency domain compression algorithm includes two methods: lossless compression and lossy compression. The lossless compression is implemented through an entropy encoding technology, for example, Huffman encoding and arithmetic encoding. The lossy compression is to obtain a higher compression ratio at the expense of image quality. The lossy compression algorithm may be a compression method based on motion estimation and prediction, for example, H.264 and high efficiency video coding (HEVC).

Different QFs (QF, QF) bring compression noise of different degrees. For example, in the foregoing DCT algorithm, compression noise is caused by a quantization matrix, and different QFs correspond to different quantization matrices. A factor matrix D in a frequency domain is obtained after the DCT is performed on an image block in the image, and the factor matrix D is similar to a factor matrix obtained after Fourier transform.

Since different compression degrees correspond to different quantization matrices, compressed factor matrices of different compression degrees may be obtained through different quantization matrices. A compressed factor matrix (for example, a factor matrix of a quantization error (compression noise) caused by compression) is obtained by performing element-by-element division on the factor matrix D and the quantization matrix Q and then performing a quantization (rounding) operation. A larger QF indicates fewer elements reserved in the upper left corner of the compressed factor matrix, resulting in greater compression noise.

For example, the factor matrix

$$D = [ \begin{matrix}162.3 & 40.6 & 20.2 & 72.3 & 30.3 & 12.5 & - 19.7 & - 11.5 \\ 30.5 & 108.4 & 10.5 & 32.3 & 27.7 & - 15.5 & 18.4 & - 2. \\ - 94.1 & - 60.1 & 12.3 & - 43.4 & - 31.3 & 6.1 & - 3.3 & 7.1 \\ - 38.6 & - 83.4 & - 5.4 & - 22.2 & - 13.5 & 15.5 & - 1.3 & 3.5 \\ - 31.3 & 17.9 & - 5.5 & - 12.4 & 14.3 & - 6. & 11.5 & - 6. \\ - 0.9 & - 11.8 & 12.8 & 0.2 & 28.1 & 12.6 & 8.4 & 2.9 \\ 4.6 & - 2.4 & 12.2 & 6.6 & - 18.7 & - 12.8 & 7.7 & 12. \\ - 10. & 11.2 & 7.8 & - 16.3 & 21.5 & 0. & 5.9 & 10.7\end{matrix} ] ,$$

a quantization matrix

$${Q}_{10} = [ \begin{matrix}80 & 60 & 50 & 80 & 120 & 200 & 255 & 255 \\ 55 & 60 & 70 & 95 & 130 & 255 & 255 & 255 \\ 70 & 65 & 80 & 120 & 200 & 255 & 255 & 255 \\ 70 & 85 & 110 & 145 & 255 & 255 & 255 & 255 \\ 90 & 110 & 185 & 255 & 255 & 255 & 255 & 255 \\ 120 & 175 & 255 & 255 & 255 & 255 & 255 & 255 \\ 245 & 255 & 255 & 255 & 255 & 255 & 255 & 255 \\ 255 & 255 & 255 & 255 & 255 & 255 & 255 & 255\end{matrix} ]$$

corresponding to a QF 10, and a quantization matrix

$${Q}_{50} = [ \begin{matrix}16 & 11 & 10 & 16 & 24 & 40 & 51 & 61 \\ 12 & 12 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ]$$

corresponding to a QF 50, and the factor matrix D is compressed through the quantization matrix Q₁₀ according to Equation

$${C}_{i , j} = round ( \frac{{D}_{i , j}}{{Q}_{i , j}} ) ,$$

to obtain a compressed factor matrix

$$C = [ \begin{matrix}10 & 4 & 2 & 5 & 1 & 0 & 0 & 0 \\ 3 & 9 & 1 & 2 & 1 & 0 & 0 & 0 \\ - 7 & - 5 & 1 & - 2 & - 1 & 0 & 0 & 0 \\ - 3 & - 5 & 0 & - 1 & 0 & 0 & 0 & 0 \\ - 2 & 1 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ] .$$

In some embodiments, compression noise of different degrees caused by compression is removed through a dynamic denoising network. Dynamic denoising is modeled as an image restoration problem, and a QF is dynamically predicted in an image restoration process, thereby better removing the compression noise caused by compression.

As for the dynamic denoising network shown in FIG. 5, the dynamic denoising network includes a network of a U-shaped structure. The network of the U-shaped structure includes an extraction network (decoupler) and a reconstruction network (reconstructor). Features are extracted layer by layer through a decoupler (including a plurality of convolutional layers (conv) and a downsampling layer) until a separation feature map is extracted, and then a reconstruction feature map is obtained through reconstruction and restoration layer by layer through a skip connection on the reconstructor (including the plurality of convolutional layers (conv) and an upsampling layer). A last layer of the decoupler is output as a QF feature, and the QF feature is predicted through a prediction network (predictor) (including a plurality of connection layers and an activation layer), to obtain a value of a predicted QF. The value of the predicted QF is modulated through a control network (controller) (including a plurality of connection layers and an activation layer), to obtain two modulation factors of γ and β, and features output by the reconstructor are modulated through the two modulation factors of γ and β. For example, an output feature of a certain layer in the reconstructor is f, and a feature f′ after modulation through two modulation factors of γ and β is equal to γ*f+β.

An image dynamically denoised through a dynamic denoising network may approximate to a low-resolution image without noise after downsampling, so that a high-resolution image may be reconstructed through a super-resolution algorithm.

The super-resolution algorithm is described below. Through the super-resolution algorithm, a series of reconstruction super-resolution operations are performed on an input low-resolution (LR) video, for example, an image sequence, to finally obtain a high-resolution image sequence.

As shown in FIG. 6, the reconstruction super-resolution operation may include three operations, for example, image frame alignment, feature extraction and fusion, and feature reconstruction. Image alignment is performed on image frames (for example, the low-resolution image), to obtain an aligned image. For example, for a t^{th} image frame, the t^{th} image frame is aligned with a (t−1)^{th} image frame in the image sequence. An alignment process is as follows. An offset (for example, a motion vector) between the t^{th} image frame and the (t−1)^{th} image frame is first calculated, and the t^{th} image frame is aligned through the motion vector, to obtain the aligned t^{th} image frame. Some embodiments are not limited to an image alignment algorithm, for example, an optical flow estimation algorithm. Then feature extraction and fusion are performed on the aligned image to obtain a fused feature. For example, feature extraction is separately performed on a t^{th} frame of the aligned image and a (t−1)^{th} frame of the aligned image, to obtain an extraction feature of the t^{th} frame of the aligned image and an extraction feature of the (t−1)^{th} frame of the aligned image. Then feature fusion (for example, feature concatenation) is performed on the extraction feature of the t^{th} frame of the aligned image and the extraction feature of the (t−1)^{th} frame of the aligned image, to obtain a fused feature. Finally, feature reconstruction is performed on the fused feature to obtain a high-resolution image. A core of the feature reconstruction is an upsampling operation. For a feature map of H*W*C, a feature map of Hs*Ws*3 is finally obtained through the upsampling operation, s representing an upsampling factor, and 3 representing an RGB channel of a final output.

The super-resolution algorithm is a supervised learning method, which is sampling paired data of an LR video and an HR video to perform supervised training. In some embodiments, the HR video may be first obtained, and the HR video is downsampled through a downsampling strategy (for example, bicubic downsampling), to obtain a corresponding LR video, for example, a low-resolution image sequence, so that the HR video and the LR video obtained through downsampling form paired data to perform supervised training.

A main point of modeling of the super-resolution algorithm is processing a low-resolution video, and compression noise produced by a compressed video is not considered. When the low-resolution video has compression noise, the compression noise affects three modules such as an image alignment module, a feature extraction module, and a feature reconstruction module. In some embodiments, dynamic denoising may be first performed on the compressed video (for example, the low-resolution video) through the foregoing dynamic denoising network, to ensure that the low-resolution image that is finally input into the super-resolution algorithm approximates to the foregoing downsampled video. No compression noise is produced.

As shown in FIG. 8, the foregoing super-resolution algorithm and the dynamic denoising network may be used as two independent modules (for example, a video super-resolution module and a dynamic denoising module), and connected in series for application. For example, a low-resolution compressed video is input to the dynamic denoising module, dynamic denoising is performed on each image in the low-resolution compressed video through the dynamic denoising module to obtain a denoised compressed video, then the denoised compressed video is input to a video super-resolution module, and video super-resolution is performed on the denoised compressed video through the video super-resolution module, to obtain a high-resolution video.

In practical application, if a higher requirement is imposed on image quality of a video, the dynamic denoising module and the video super-resolution module may be jointly optimized and trained, to obtain a better model.

Based on the above, according to the image processing method provided in some embodiments, the QF of the image after video compression can be analyzed dynamically, and compression noise brought by different compression degrees is eliminated, to obtain images with the same quality, thereby improving quality of a video reconstructed through the super-resolution algorithm.

At this point, the image processing method has been described in combination with the exemplary applications and implementations of the electronic device provided in some embodiments. Some embodiments further provide an image processing apparatus. In practical application, each functional module in the image processing apparatus may be collaboratively implemented by a hardware resource of an electronic device (for example, a terminal device, a server, or a server cluster), for example, a computing resource such as a processor, a communication resource (for example, configured to support implementation of communication in various manners such as an optical cable and a cellular network), and a memory. FIG. 2 shows the image processing apparatus 555 stored in the memory 550, which may be software in forms such as a program and a plug-in, for example, some embodiments such as a software module designed in a programming language such as C/C++ or Java, application software designed in a programming language such as C/C++ or Java, a software module in a large software system, an application program interface, a plug-in, or a cloud service. Different implementations are described below through examples.

The image processing apparatus 555 includes a series of modules, including an extraction module 5551, a reconstruction module 5552, a prediction module 5553, and a denoising module 5554. A solution of cooperatively implementing image processing through the modules in the image processing apparatus 555 provided in some embodiments continues to be described below.

The extraction module 5551 is configured to perform feature extraction on a compressed image to obtain a compression feature map of the compressed image. The reconstruction module 5552 is configured to perform reconstruction on the compression feature map to obtain a reconstruction feature map of the compressed image. The prediction module 5553 is configured to perform QF prediction on the compression feature map to obtain a QF of the compressed image. The denoising module 5554 is configured to perform denoising on the reconstruction feature map based on the QF, to obtain a denoised compressed image, the denoised compressed image being an image after compression noise is removed from the compressed image.

In some embodiments, the extraction module 5551 is further configured to call an extraction network, and perform downsampling and encoding on the compressed image through the extraction network, to obtain a compression feature map of the compressed image. The reconstruction module 5552 is further configured to call a reconstruction network, and perform upsampling and decoding on the compression feature map through the reconstruction network, to obtain a reconstruction feature map of the compressed image.

In some embodiments, the extraction network includes a plurality of cascaded encoding layers. The extraction module 5551 is further configured to: perform downsampling and encoding on the compressed image through a first encoding layer of the plurality of cascaded encoding layers; output an encoding result of the first encoding layer to a subsequent cascaded encoding layer, and further perform the downsampling and encoding and the outputting of the encoding result through the subsequent cascaded encoding layer until a last encoding layer; and use an encoding result output by the last encoding layer as the compression feature map of the compressed image.

In some embodiments, each of the encoding layers includes a plurality of cascaded convolutional layers and a downsampling layer. The extraction module 5551 is further configured to perform cascaded convolution on an encoding result output by an (i−1)^{th} encoding layer through a plurality of cascaded convolutional layers included in an i^{th} encoding layer, to obtain a convolution feature map; and perform downsampling on the convolution feature map through a downsampling layer included in the i^{th} encoding layer, to obtain an encoding result of the i^{th} encoding layer, and output the encoding result of the i^{th} encoding layer to an (i+1)^{th} encoding layer, i being an increasing positive integer, 1<i<N, and N being a total quantity of encoding layers.

In some embodiments, the reconstruction network includes a plurality of cascaded decoding layers. the reconstruction module 5552 is further configured to: perform upsampling and decoding on the compression feature map through a first decoding layer of the plurality of cascaded decoding layers; output a decoding result of the first decoding layer to a subsequent cascaded decoding layer, and further perform the upsampling and decoding and the outputting of the decoding result through the subsequent cascaded decoding layer until a last decoding layer; and use a decoding result output by the last decoding layer as the reconstruction feature map of the compressed image.

In some embodiments, each decoding layer includes a plurality of cascaded convolutional layers and an upsampling layer. The reconstruction module 5552 is further configured to perform cascaded convolution on a decoding result output by a (j−1)^{th} decoding layer through a plurality of cascaded convolutional layers included in a j^{th} decoding layer, to obtain a convolution feature map; and perform upsampling on the convolution feature map through an upsampling layer included in the j^{th} decoding layer, to obtain a decoding result of the j^{th} decoding layer, and output the decoding result of the j^{th} decoding layer to a (j+1)^{th} decoding layer, j being an increasing positive integer, 1<j<M, and M being a total quantity of decoding layers.

In some embodiments, the reconstruction module 5552 is further configured to perform denoising on a decoding result output by each of the decoding layers based on the QF, to obtain a denoised decoding result output by each of the decoding layers, and use the denoised decoding result output by each of the decoding layers as an input of a next decoding layer.

In some embodiments, when the extraction network includes the plurality of cascaded encoding layers, the reconstruction network includes the plurality of cascaded decoding layers, and a cross-layer connection exists between each of the encoding layers and each of the decoding layers. The reconstruction module 5552 is further configured to: perform upsampling and decoding on the compression feature map through a first decoding layer of the plurality of cascaded decoding layers; fuse a decoding result of the upsampling and decoding and an encoding result output by an encoding layer in cross-layer connection with the second decoding layer, and output a fusion result to a subsequent cascaded decoding layer as a final decoding result of the first decoding layer; further perform the upsampling and decoding, the fusion of the decoding results, and the outputting of the final decoding result through the subsequent cascaded decoding layer; and use a decoding result output by the last decoding layer as the reconstruction feature map of the compressed image.

In some embodiments, the reconstruction module 5552 is further configured to perform denoising on a final decoding result output by each of the decoding layers based on the QF, to obtain a denoised decoding result output by each of the decoding layers, and use the denoised decoding result output by each of the decoding layers as an input of a next decoding layer.

In some embodiments, the denoising module 5554 is further configured to: perform modulation on the QF of the compressed image, to obtain a modulation factor corresponding to the QF; and perform denoising on the reconstruction feature map based on the modulation factor, to obtain a denoised compressed image.

In some embodiments, the denoising module 5554 is further configured to perform full connection of the modulation factor on the QF of the compressed image, to obtain a first full connection feature; and perform activation of the modulation factor on the first full connection feature, to obtain the modulation factor corresponding to the QF.

In some embodiments, the modulation factor includes a first factor and a second factor. The denoising module 5554 is further configured to multiply the reconstruction feature map by the first factor, to obtain a product result; and add the product result and the second factor, to obtain the denoised compressed image.

In some embodiments, the prediction module 5553 is further configured to perform full connection of the QF on the compression feature map, to obtain a second full connection feature; and perform activation of the QF on the second full connection feature, to obtain the QF of the compressed image.

In some embodiments, the reconstruction module 5555 is configured to perform high-resolution image reconstruction on the denoised compressed image, to obtain a high-resolution image.

In some embodiments, the reconstruction module 5555 is further configured to: determine an adjacent image of the denoised compressed image, the adjacent image being a denoised compressed image adjacent to the denoised compressed image in an image sequence; perform feature extraction on the denoised compressed image and the adjacent image, to obtain a first feature of the denoised compressed image and a second feature of the adjacent image; perform fusion on the first feature and the second feature, to obtain a fused feature of the denoised compressed image; and perform reconstruction on the fused feature of the denoised compressed image, to obtain the high-resolution image.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

Some embodiments provide a computer program product, the computer program product including a computer program or a computer-executable instruction, the computer program or the computer-executable instruction being stored in a computer-readable storage medium. A processor of an electronic device reads the computer program or the computer-executable instruction from the computer-readable storage medium, and the processor executes the computer program or the computer-executable instruction, so that the electronic device performs the foregoing image processing method in some embodiments.

Some embodiments provide a computer-readable storage medium having a computer-executable instruction or a computer program stored therein, the computer-executable instruction or the computer program, when executed by a processor, causing the processor to perform the image processing method provided in some embodiments, for example, the image processing method shown in FIG. 3A to FIG. 3F and FIG. 4.

In some embodiments, the computer-readable storage medium may be a memory such as a ferromagnetic RAM (FRAM), a ROM, a programmable ROM (PROM), an erasable PROM (EPROM), an electrically EPROM (EEPROM), a flash memory, a magnetic surface memory, a compact disc, or a compact disc ROM (CD-ROM), or may be various devices including one or any combination of the foregoing memories.

In some embodiments, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or other units for use in a computing environment.

In an example, the computer-executable instruction may but may not necessarily correspond to a file in a file system, may be stored in a part of the file for storing other programs or data, for example, stored in one or more scripts in a hypertext markup language (HTML) document, stored in a single file used for the discussed program, or stored in a plurality of collaborative files (for example, files storing one or more modules, a subprogram, or a code part).

In an example, the computer-executable instruction may be deployed to be executed on one electronic device, or executed on a plurality of electronic devices located at one location, or executed on a plurality of electronic devices distributed at a plurality of locations and connected through a communication network.

Some embodiments relate to related data such as user information. User permission or consent should be obtained when some embodiments are applied to products or technologies, and collection, use, and processing of related data should comply with relevant laws, regulations, and standards of relevant countries and regions.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An image processing method, for an electronic device comprising:
performing feature extraction on a compressed image to obtain a compression feature map of the compressed image;
performing reconstruction on the compression feature map to obtain a reconstruction feature map of the compressed image;
performing quality factor (QF) prediction on the compression feature map to obtain a QF of the compressed image; and
generating a denoised compressed image having compression noise reduced or removed from the compressed image by performing denoising on the reconstruction feature map based on the QF.

2. The image processing method according to claim 1, wherein the performing feature extraction comprises calling an extraction network, and performing downsampling and encoding on the compressed image via the extraction network, to obtain the compression feature map, and
wherein the performing reconstruction comprises calling a reconstruction network, and performing upsampling and decoding on the compression feature map via the reconstruction network, to obtain the reconstruction feature map.

3. The image processing method according to claim 2, wherein the extraction network comprises a plurality of cascaded encoding layers, and
wherein the performing downsampling and encoding comprises:
performing downsampling and encoding on the compressed image via a first encoding layer of the plurality of cascaded encoding layers;
outputting a first encoding result of the first encoding layer to a subsequent cascaded encoding layer, and further performing the downsampling and encoding and the outputting of the first encoding result via the subsequent cascaded encoding layer until a last encoding layer; and
using a second encoding result output by the last encoding layer as the compression feature map.

4. The image processing method according to claim 3, wherein an i^{th} encoding layer of the plurality of cascaded encoding layers comprises a first plurality of cascaded convolutional layers and a first downsampling layer,
wherein the further performing the downsampling and encoding comprises:
performing cascaded convolution on a third encoding result output by an (i−1)^{th} encoding layer via the first plurality of cascaded convolutional layers in the i^{th} encoding layer, to obtain a first convolution feature map; and
performing downsampling on the first convolution feature map via the first downsampling layer in the i^{th} encoding layer, to obtain a fourth encoding result of the i^{th} encoding layer, and outputting the fourth encoding result of the i^{th} encoding layer to an (i+1)^{th} encoding layer, and
wherein i is an increasing positive integer such that 1<i<N, and N is a total quantity of encoding layers.

5. The image processing method according to claim 3, wherein the reconstruction network comprises a plurality of cascaded decoding layers, and
wherein the performing upsampling and decoding comprises:
performing upsampling and decoding on the compression feature map via a first decoding layer of the plurality of cascaded decoding layers;
outputting a first decoding result of the first decoding layer to a subsequent cascaded decoding layer, and further performing the upsampling and decoding and the outputting of the first decoding result via the subsequent cascaded decoding layer until a last decoding layer; and
using a second decoding result output by the last decoding layer as the reconstruction feature map.

6. The image processing method according to claim 5, wherein a j^{th} decoding layer of the plurality of cascaded decoding layers comprises a first plurality of cascaded convolutional layers and a first upsampling layer, and
wherein the further performing the upsampling and decoding comprises:
performing cascaded convolution on a first decoding result output by a (j−1)^{th} decoding layer via the first plurality of cascaded convolutional layers in the j^{th} decoding layer, to obtain a convolution feature map; and
performing upsampling on the convolution feature map via the first upsampling layer in the j^{th} decoding layer, to obtain a third decoding result of the j^{th} decoding layer, and outputting the third decoding result of the j^{th} decoding layer to a (j+1)^{th} decoding layer,
wherein j is an increasing positive integer such that 1<j<M, and M is a total quantity of decoding layers.

7. The image processing method according to claim 5, further comprising:
performing denoising on a plurality of decoding results output by the plurality of cascaded decoding layers based on the QF, to obtain a plurality of denoised decoding results, and using the plurality of denoised decoding results as an input of a next decoding layer.

8. The image processing method according to claim 5, wherein a plurality of cross-layer connection exists between the plurality of cascaded encoding layers and the plurality of cascaded decoding layers, and
wherein the performing upsampling and decoding on the compression feature map comprises:
performing upsampling and decoding on the compression feature map via the first decoding layer;
fusing a second decoding result of the upsampling and decoding and a third encoding result output by an encoding layer that has a first cross-layer connection with a second decoding layer, and outputting a third decoding result based on a fusion result of a subsequent cascaded decoding layer;
further performing the upsampling and decoding, the fusing the second decoding result, and the outputting of the third decoding result; and
using a fourth decoding result output by the last decoding layer as the reconstruction feature map.

9. The image processing method according to claim 8, further comprising:
performing denoising on a plurality of final decoding output by the plurality of cascaded decoding layers based on the QF, to obtain a plurality of denoised decoding results, and using the plurality of denoised decoding results as an input of a next decoding layer.

10. The image processing method according to claim 1, wherein the performing denoising on the reconstruction feature map comprises:
performing modulation on the QF, to obtain a modulation factor corresponding to the QF; and
performing denoising on the reconstruction feature map based on the modulation factor, to obtain the denoised compressed image.

11. An image processing apparatus, comprising:
at least one memory configured to store computer program code; and
at least one processor configured to read the program code and operate as instructed by the program code, the program code comprising:
extraction code configured to cause at least one of the at least one processor to perform feature extraction on a compressed image to obtain a compression feature map of the compressed image;
reconstruction code configured to cause at least one of the at least one processor to perform reconstruction on the compression feature map to obtain a reconstruction feature map of the compressed image;
prediction code configured to cause at least one of the at least one processor to perform QF prediction on the compression feature map to obtain a QF of the compressed image; and
denoising code configured to cause at least one of the at least one processor to generate a denoised compressed image having compression noise reduced or removed from the compressed image by performing denoising on the reconstruction feature map based on the QF.

12. The image processing apparatus according to claim 11, wherein the extraction code is configured to cause at least one of the at least one processor to call an extraction network, and perform downsampling and encoding on the compressed image via the extraction network, to obtain the compression feature map, and
wherein the reconstruction code is configured to cause at least one of the at least one processor to call a reconstruction network, and perform upsampling and decoding on the compression feature map via the reconstruction network, to obtain the reconstruction feature map.

13. The image processing apparatus according to claim 12, wherein the extraction network comprises a plurality of cascaded encoding layers, and
wherein the extraction code is configured to cause at least one of the at least one processor to:
perform downsampling and encoding on the compressed image via a first encoding layer of the plurality of cascaded encoding layers;
output a first encoding result of the first encoding layer to a subsequent cascaded encoding layer, and further perform the downsampling and encoding and the output of the first encoding result via the subsequent cascaded encoding layer until a last encoding layer; and
use a second encoding result output by the last encoding layer as the compression feature map.

14. The image processing apparatus according to claim 13, wherein an i^{th} encoding layer of the plurality of cascaded encoding layers comprises a first plurality of cascaded convolutional layers and a first downsampling layer,
wherein the extraction code is configured to cause at least one of the at least one processor to:
perform cascaded convolution on a third encoding result output by an (i−1)^{th} encoding layer via the first plurality of cascaded convolutional layers in the i^{th} encoding layer, to obtain a first convolution feature map; and
perform downsampling on the first convolution feature map via the first downsampling layer in the i^{th} encoding layer, to obtain a fourth encoding result of the i^{th} encoding layer, and output the fourth encoding result of the i^{th} encoding layer to an (i+1)^{th} encoding layer,
wherein i is an increasing positive integer such that 1<i<N, and N is a total quantity of encoding layers.

15. The image processing apparatus according to claim 13, wherein the reconstruction network comprises a plurality of cascaded decoding layers, and
wherein the extraction code is configured to cause at least one of the at least one processor to:
perform upsampling and decoding on the compression feature map via a first decoding layer of the plurality of cascaded decoding layers;
output a first decoding result of the first decoding layer to a subsequent cascaded decoding layer, and further perform the upsampling and decoding and the output of the first decoding result via the subsequent cascaded decoding layer until a last decoding layer; and
use a second decoding result output by the last decoding layer as the reconstruction feature map.

16. The image processing apparatus according to claim 15, wherein a j^{th} decoding layer of the plurality of cascaded decoding layers comprises a first plurality of cascaded convolutional layers and a first upsampling layer, and
wherein the extraction code is configured to cause at least one of the at least one processor to:
perform cascaded convolution on a first decoding result output by a (j−1)^{th} decoding layer via the first plurality of cascaded convolutional layers in the j^{th} decoding layer, to obtain a convolution feature map;
perform upsampling on the convolution feature map via the first upsampling layer in the j^{th} decoding layer, to obtain a third decoding result of the j^{th} decoding layer, and output the third decoding result of the j^{th} decoding layer to a (j+1)^{th} decoding layer,
wherein j is an increasing positive integer such that 1<j<M, and M is a total quantity of decoding layers.

17. The image processing apparatus according to claim 15, wherein the denoising code is further configured to cause at least one of the at least on processor to:
perform denoising on a plurality of decoding results output by the plurality of cascaded decoding layers based on the QF, to obtain a plurality of denoised decoding results, and use the plurality of denoised decoding results as an input of a next decoding layer.

18. The image processing apparatus according to claim 15, wherein a plurality of cross-layer connection exists between the plurality of cascaded encoding layers and the plurality of cascaded decoding layers, and
wherein the extraction code is configured to cause at least one of the at least one processor to:
perform upsampling and decoding on the compression feature map via the first decoding layer;
fuse a second decoding result of the upsampling and decoding and a third encoding result output by an encoding layer that has a first cross-layer connection with a second decoding layer, and output a third decoding result based on a fusion result of a subsequent cascaded decoding layer;
further perform the upsampling and decoding, the fuse the second decoding result, and the outputting of the third decoding result; and
use a fourth decoding result output by the last decoding layer as the reconstruction feature map.

19. The image processing apparatus according to claim 18, wherein the denoising code is further configured to cause at least one of the at least on processor to:
perform denoising on a plurality of final decoding output by the plurality of cascaded decoding layers based on the QF, to obtain a plurality of denoised decoding results, and use the plurality of denoised decoding results as an input of a next decoding layer.

20. A non-transitory computer-readable storage medium, storing computer code which, when executed by at least one processor, causes the at least one processor to at least:
perform feature extraction on a compressed image to obtain a compression feature map of the compressed image;
perform reconstruction on the compression feature map to obtain a reconstruction feature map of the compressed image;
perform quality factor (QF) prediction on the compression feature map to obtain a QF of the compressed image; and
generate a denoised compressed image having compression noise reduced or removed from the compressed image by performing denoising on the reconstruction feature map based on the QF.
